(19) United States
(12) Patent Application Publication
(10) Pub. No.: US 2018/0252082 A1
(43) Pub. Date: Sep. 6, 2018

(54) METHODS OF DEGRADING POLYMER COMPOSITES IN AQUEOUS FLUIDS USING CATALYSTS

(71) Applicant: SCHLUMBERGER TECHNOLOGY CORPORATION, Sugar Land, TX (US)

(72) Inventors: Shitong S. ZHU, Waban, MA (US); Miranda AMARANTE, Somerville, MA (US); Meng QU, Waltham, MA (US)

(21) Appl. No.: 15/760,465

(22) PCT Filed: Sep. 12, 2016
(86) PCT No.: PCT/US2016/051214

§ 371 Date: Mar. 15, 2018

Related U.S. Application Data
(60) Provisional application No. 62/220,632, filed on Sep. 18, 2015.

(51) Int. Cl. E21B 43/25; B01J 27/10; B01J 27/125; B01J 23/04; B01J 23/06; B01J 21/02; B01J 21/10; E21B 23/06; E21B 33/12

(52) U.S. Cl. CPC E21B 43/25; B01J 27/10; B01J 27/125; B01J 23/04; C08L 67/00; B01J 21/02; B01J 21/10; E21B 23/06; E21B 33/1208; B01J 23/06

(57) ABSTRACT

Methods may include contacting a degradable polymer in a wellbore traversing a subterranean formation with a treatment fluid, wherein the treatment fluid is formulated with one or more polymer degrading catalysts; and allowing the degradable polymer composite to at least partially degrade. In another aspect, methods may be directed to designing a wellbore treatment that includes determining at least one degradation characteristic for one or more degradable polymers; formulating an aqueous treatment fluid based on the determined values, wherein the aqueous treatment fluid comprises one or more polymer degrading catalysts; contacting the degradable polymer with an aqueous fluid; and allowing the degradable polymer to at least partially degrade the degradable polymer.

### CROSS-REFERENCE TO RELATED APPLICATION

This application claims the benefit of U.S. Application Ser. No. 62/220,632, filed Sep. 18, 2015, and entitled “Methods of degrading polymer composites in aqueous fluids using catalysts”, which is incorporated herein by reference in its entirety.

### BACKGROUND

Natural resources such as gas, oil, and water residing in a subterranean formation or zone may be recovered by drilling a wellbore into a subterranean formation while circulating various wellbore fluids. During subsequent wellbore operations, numerous tools and fluids may be emplaced within the wellbore to perform a variety of functions. For example, wellbore tools such as frac plugs, bridge plugs, and packers may be used to isolate one pressure zone of the formation from another by creating a seal against emplaced casing or along the wellbore wall.

Once the wellbore is completed, production tubing and/or screens may be emplaced within one or more intervals of the formation prior to hydrocarbon production. During production operations, sand control methods and/or devices are used to prevent sand particles in the formation from entering and plugging the production screens and tubes in order to extend the life of the well.

Tools utilized in all stages of wellbore operations may be constructed from various materials suited for activities at temperatures and pressures encountered in downhole environments. Further, downhole tools may also be outfitted with specialty parts made from performance materials that are the same or different from the remainder of the tool body such as seals, chevron seals, o-rings, packer elements, gaskets, and movable parts such as slips, sleeves, and drop balls.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments of the present disclosure are directed to methods that include contacting a degradable polymer in a wellbore traversing a subterranean formation with a treatment fluid, wherein the treatment fluid is formulated with one or more polymer degrading catalysts; and allowing the degradable polymer composite to at least partially degrade.

In another aspect, embodiments of the present disclosure are directed to methods of designing a wellbore treatment that includes determining at least one degradation characteristic for one or more degradable polymers; formulating an aqueous treatment fluid based on the determined values, wherein the aqueous treatment fluid comprises one or more polymer degrading catalysts; contacting the degradable polymer with an aqueous fluid; and allowing the degradable polymer to at least partially degrade.

Other aspects and advantages of the invention will be apparent from the following description and the appended claims.

### BRIEF DESCRIPTION OF THE DRAWINGS

The subject disclosure is further described in the detailed description which follows, in reference to the noted plurality of drawings by way of non-limiting examples of the subject disclosure, in which like reference numerals represent similar parts throughout the several views of the drawings.

FIG. 1 is a graphical representation of the change in mass for a polymer sample exposed to water and aqueous solutions of various catalysts at different temperatures as a function of time in accordance with embodiments of the present disclosure;

FIG. 2 is a graphical representation of the change in volume for a polymer sample exposed to water and aqueous solutions of various catalysts at different temperatures as a function of time in accordance with embodiments of the present disclosure;

FIG. 3 is a graphical representation depicting an Arrhenius plot for diffusion constants for water and aqueous catalyst solutions in accordance with the present disclosure;

FIG. 4 is a graphical representation of percent weight loss of polymer from a polymer composite (solid bar: total weight loss %. Pattern bar: polymer weight loss %) as a function of catalyst exposure for samples submerged in aqueous solutions of polymer degrading catalysts for 7 days and at 150° C.;

FIG. 5 is a graphical representation depicting the weight loss percentage as a function of degradation time at 150° C. for a polyamide composite exposed to aqueous solutions of AlCl₃ in accordance with embodiments of the present disclosure;

FIG. 6 is a graphical representation depicting the weight loss percentage as a function of degradation time at 150° C. for a polyamide composite exposed to an aqueous solution of AlCl₃ in accordance with embodiments of the present disclosure;

FIG. 7 is a graphical representation depicting the weight loss percentage after three days at 150° C. for a polyamide composite exposed to various aqueous catalyst formulations with produced water in accordance with embodiments of the present disclosure;

FIGS. 8 and 9 are graphical representations depicting the first order reaction kinetics for AlCl₃ catalyst solutions at various temperatures in accordance with embodiments of the present disclosure;

FIG. 10 is a graphical representation depicting attenuated total reflectance Fourier transform infrared (ATR-FTIR) spectra showing a comparison between a polyamide before and after various time length exposures to a catalyst solution of AlCl₃ in accordance with embodiments of the present disclosure;

FIGS. 11 and 12 are graphical representations depicting the change in the fraction of crystallinity in a polyamide exposed to an aqueous catalyst solution in accordance with the present disclosure at various temperatures; and

FIGS. 13 and 14 are graphical representations depicting the change in compressive and tensile strength of a polyamide exposed to an aqueous catalyst solution in accordance with the present disclosure at various temperatures.

### DETAILED DESCRIPTION

The particulars shown herein are by way of example and for purposes of illustrative discussion of the examples of the subject disclosure only and are presented in the cause of providing what is believed to be the most useful and readily understood description of the principles and conceptual aspects of the subject disclosure. In this regard, no attempt is made to show structural details in more detail than is necessary, the description taken with the drawings making apparent to those skilled in the art how the several forms of the subject disclosure may be embodied in practice. Furthermore, like reference numbers and designations in the various drawings indicate like elements.

In one aspect, embodiments of the present disclosure are directed to the use of polymer degrading catalysts that accelerate the hydrolysis of a degradable polymer when contacted or submerged in an aqueous solution containing the catalyst. In one or more embodiments, the polymer degrading catalyst may be added to an aqueous solution as an acid, base, or precursor of an acid or base that may be used to accelerate the degradation of a degradable polymer or composite. In some embodiments, polymer degrading catalysts may include compounds that generate Lewis acids, such as ZnCl₂ and AlCl₃.

In some embodiments, polymer degrading catalysts are used to accelerate the hydrolytic degradation of the polymer in downhole conditions, including elevated temperatures and pressures. For example, treatment solutions containing a polymer degrading catalyst in accordance with the present disclosure may be introduced into a wellbore containing a tool composed of, or having one or more components composed of, a degradable polymer, in order to promote degradation and/or modify the mechanical properties of the tool to aid removal prior to subsequent wellbore operations.

The term “degradation” as used herein refers to any process that converts at least a portion of a degradable material from a first physical state to a second physical state. For example, degradation may be in the form of dissolution, disintegration, fragmentation, deformation, distortion, swelling, or shrinkage. Degradable materials can change their mechanical, physical and other responsive properties upon thermal, hygroscopic, and/or chemical interaction with their environment, or upon interaction with mechanical, physical or chemical triggers. They must provide acceptable transient performance, and then degrade or dissolve away in the downhole environment, which saves the time and cost associated with drilling out or retrieving the devices. Because of this time-and cost-saving potential, degradable materials are of particular interest to the oil field industry. Degradable materials can be used for zonal isolation, bridging, plugging or as degradable parts/components in downhole devices. In some applications, the degradable materials are required to have certain mechanical properties in order to fulfill their intended functions before degradation starts.

In another aspect, embodiments of the present disclosure are directed to methods of designing a treatment fluid containing one or more polymer degrading catalysts to dissolve or weaken a degradable polymer present in a wellbore to aid removal. For example, the determination of physical and chemical properties for a given polymer, such as the number average molecular weight, the coefficient of water diffusion through the polymer, and the rate constant of hydrolysis, may be used to formulate a treatment fluid. Factors that may affect the rate of degradation include the concentration of the catalyst, the susceptibility of the polymer to hydrolysis, reaction temperature, and the structure of the polymer and the accessibility of the interior to aqueous fluids including the level of crosslinking and porosity of the polymeric structure.

In some embodiments, determination of polymer samples of the target degradable polymer, allows the prediction of the degradation behavior of large, bulk materials in downhole conditions using a temperature-dependent model, and aids in the selection of the particular polymer degrading catalyst or catalyst, in addition to concentration and base fluid composition. Further, the performance of the treatment fluid on the target degradable polymer may be tailored to ensure sufficient degradation rates based on the knowledge of the chemistry of connate or added wellbore fluids present downhole.

Methods in accordance with the present disclosure may incorporate testing using Fourier transform infrared spectroscopy (FTIR), differential scanning calorimetry (DSC), mechanical testing such as Instron™ testing, and end group analysis to analyze the hydrolytic degradation properties of a particular degradable polymer. Testing methods may determine a range of characteristics of a degradable polymer such as changes in crystallinity, molecular weight, mechanical strength, mass loss into solution, porosity, rates of hydrolytic degradation, and fluid diffusion through the degradable polymer. In some embodiments, testing may be conducted on smaller samples to predict the degradation behavior of bulk materials in downhole conditions using temperature-dependent modeling.

### Polymer Degrading Catalysts

Polymer degrading catalysts in accordance with the present disclosure may be incorporated into a wellbore fluid (e.g., an aqueous wellbore fluid) that is added to a wellbore containing a degradable polymer. When exposed to the wellbore fluid containing a polymer degrading catalyst, the catalyst may be absorbed into the matrix of the degradable polymer and modify the rate of the hydrolytic reaction between free water present in the wellbore fluid and hydrolysable bonds in the backbone chain of the degradable polymer or crosslinks in the surrounding polymer matrix. In some embodiments, polymer degrading catalysts may also destabilize the amorphous phase of a degradable polymer by interrupting hydrogen bonding between neighboring polymer chains, which may increase free water access and increase the rate of hydrolysis. The polymer degrading catalyst may also be selected on the basis of the exothermic activity of the hydration reaction of the catalyst. For example, hydration of the catalyst may increase the temperature and thereby the hydrolysis rate and/or participate as a catalyst to the underlying hydrolysis reaction between the aqueous fluid and the polymer matrix.

In some embodiments, Lewis acids, or salts thereof, may be used as a polymer degrading catalyst in accordance with the present disclosure to catalyze the reaction of water with hydrolysable bonds, such as amides, imides, anhydrides, carbamates, ureas, esters, and the like. Lewis acids in accordance with the present disclosure may also be useful, because treatment fluids containing such catalysts may be less corrosive to field equipment when compared with strong acids or bases. Lewis acids used in an aqueous solution for catalyzing hydrolysis may include metal ions such as Zn²⁺, Al³⁺, Fe³⁺, Be²⁺, and the like. In some embodiments, polymer degrading catalysts may include, but are not limited to, TiCl₄, FeCl₃, ZnCl₂, ZrCl₂, AlCl₃, GaCl₃, BCl₃, ZnF₂, LiCl, MgCl₂, AlF₃, SnCl₄, SbCl₅, SbCl₃, HfCl₄, ReCl₅; ScCl₃, InCl₃, BiCl₃; NbCl₅, MoCl₃, MoCl₅, SnCl₂, TaCl₅, WCl₅, WCl₆, ReCl₃, TlCl₃; SiCl₄, FeCl₂, CoCl₂, CuCl, CuCl₂, GeCl₄, YCl₃, OsCl₃, PtCl₂, RuCl₃, VCl₃, CrCl₃, MnCl₂, NiCl₂, RhCl₃, PdCl₂, AgCl, CdCl₂, IrCl₃, AuCl, HgCl₂, HgCl, PbCl₂, sodium borate, sodium pentaborate, and sodium tetraborate.

Polymer degrading catalysts in accordance with the present embodiments may also be bases or base precursors that could accelerate the amide hydrolysis in aqueous fluids. In some embodiments, polymer degrading catalysts may be of the formula MX where M represents a divalent or trivalent metal of one of the Periodic Table Groups 2, 8, 9, 10, 11, 12, and mixtures thereof; and X represents oxygen, hydroxide, or halide. Polymer degrading catalysts may also be metal oxides and hydroxides that include, but are not limited to, KOH, NaOH, Ca(OH)₂, Mg(OH)₂, CaCO₃, Al(OH)₃, MgO, CaO, ZnO, borate, etc.

The concentration of the polymer degrading catalyst in an aqueous solution in accordance with the present disclosure may range from a percent weight polymer degrading catalyst by weight of aqueous solution (wt %) of 0.5 wt % to 15 wt % in some embodiments, or from 1 wt % to 10 wt % in other embodiments. The amount needed will vary, of course, depending upon the type of degradable polymer targeted, type of polymer degrading catalyst, presence of other chemicals in the reaction, and temperature conditions encountered in the treated zone.

In one or more embodiments, the concentration of the polymer degrading catalyst may be selected based on the mass of the degradable polymer, on the basis of the mole ratio of degradable bond in the polymer to mole of polymer degrading catalyst in treatment fluid. Treatment fluids in accordance with the present disclosure may contain a concentration based on a ratio of degradable bonds in the polymer and the moles of the polymer degrading catalyst of 5:1 to 1:1 in some embodiments, and from 4:1 to 3:1 in other embodiments.

### Base Fluids

Hydrolysis of degradable polymers in accordance with embodiments of the present disclosure may be initiated by contacting a degradable polymer with a solution of polymer degrading catalyst in aqueous fluid. Aqueous fluids in accordance with the present disclosure may include at least one of fresh water, sea water, brine, frac water, produced water, mixtures of water and water-soluble organic compounds, and mixtures thereof. In various embodiments, the aqueous fluid may be a brine, which may include seawater, aqueous solutions wherein the salt concentration is less than that of sea water, or aqueous solutions wherein the salt concentration is greater than that of sea water. Salts that may be found in seawater include, but are not limited to, sodium, calcium, aluminum, magnesium, potassium, strontium, and lithium salts of chlorides, bromides, carbonates, iodides, chlorates, bromates, formates, nitrates, oxides, sulfates, silicates, phosphates and fluorides. Salts that may be incorporated into a brine include any one or more of those present in natural seawater or any other organic or inorganic dissolved salts.

Other suitable base fluids useful in methods described herein may be oil-in-water emulsions or water-in-oil emulsions in one or more embodiments. Suitable oil-based or oleaginous fluids that may be used to formulate emulsions may include a natural or synthetic oil and in some embodiments, the oleaginous fluid may be selected from the group including diesel oil; mineral oil; a synthetic oil, such as hydrogenated and unhydrogenated olefins including polyalpha olefins, linear and branch olefins and the like, polydiorganosiloxanes, siloxanes, or organosiloxanes, esters of fatty acids, specifically straight chain, branched and cyclical alkyl ethers of fatty acids, mixtures thereof and similar compounds known to one of skill in the art; and mixtures thereof.

### Degradable Polymers

In one or more embodiments, degradable polymers may be used to form the matrix or continuous phase of the degradable polymer composites. In some embodiments, degradable polymers may include thermoplastic composites containing hydrolysable chemical bonds in the polymer chains, such as polyamide (PA), polyamideimide (PAI) and polyester (PET, PBT, etc). In some embodiments, the polymer may be a polyamide, such as PA6 or Nylon 6.

In one or more embodiments, degradation of the material may be tuned by increasing or decreasing the number of hydrolysable bonds in the constituent polymers of the degradable polymer. Hydrolysable bonds react with water through nucleophilic displacement, resulting in the formation of a new covalent bond with a hydroxyl (OH) group that displaces the previous bond and produces a leaving group. In some embodiments, deterioration/loss of mechanical strength of a degradable material may be the result of hydrolytic bond cleavage that results in disintegration into shorter chain polymers and monomers. Degradable polymer composites in accordance with the present disclosure may include polymers, copolymers, and higher order polymers having hydrolysable bonds incorporated in one or more polymer chains. Examples of hydrolysable bonds include esters, amides, urethanes, anhydrides, carbamates, ureas, and the like.

Degradable polymers in accordance with the present disclosure may include polymers, copolymers, and higher order polymers (such as terpolymers and quaternary polymers), and blends of various types of polymers. In one or more embodiments, polymer systems may exhibit primarily crystalline or amorphous character, and exhibit either melt or glass transition behavior respectively.

Due to relatively strong intermolecular forces, crystalline and semicrystalline polymers resist softening and the elastic modulus for these materials normally changes only at temperatures above the melting temperature (Tm). Amorphous polymers on the other hand, undergo a reversible transition that when exposed to increasing temperature referred to as a “glass transition.” Similarly, “glass transition range” describes the temperature range in which the viscous component of an amorphous phase within a polymer increases and the observable physical and mechanical properties undergo a change as the amorphous phase begins to enter a molten or rubber-like state. Below the glass transition range characteristic to a given polymer, the amorphous phase of a polymer is in a glassy state that is hard and fragile. However, under an external force, amorphous polymers may still undergo reversible or elastic deformation and permanent or viscous deformation. Another useful metric is the glass transition temperature (Tg) in which the slope of the curve of the specific volume as a function of temperature for the material increases during the transition from a glass to liquid.

In one or more embodiments, degradable polymer composites may include block copolymers, which may contain both crystalline and amorphous domains. Because most polymers are incompatible with one another, block polymers may “microphase separate” to form periodic structures in which one fraction of the polymer remains amorphous, allowing polymer chains to mix and entangle, while a second fraction may interlock to form crystalline structures.

In one or more embodiments, degradable polymers may include polyester amides (PEA); polyethylene terephthalate (PET), polybutylene terephthalate (PBT), polyamide, polyetheresteramide (PEEA); polycarbonateesteramides (PCEA); polyether-block-amides such as those prepared from polyamide 6, polyamide 11, or polyamide 12 copolymerized with an alcohol terminated polyether; polyphthalamide; copolyester elastomers (COPE); thermoplastic polyurethane elastomers prepared from polyols of poly(ethylene adipate) glycol, poly(butylene-1,4 adipate) glycol, poly(ethylene butylene-1,4 adipate) glycol, poly(hexamethylene-2,2-dimethylpropylene adipate) glycol, polycaprolactone glycol, poly(diethylene glycol adipate) glycol, poly(hexadiol-1,6 carbonate) diol, poly(oxytetramethylene) glycol); and blends of these polymers. Other examples of commercially available polymer products suitable for use as a degradable material include Hytrel® polymers (DuPont®), Zytel® polymer (DuPont), Vestamid® E (Evonik), Texin®, Desmoflex®, Desmovit®, Desmosint® (Bayer), Carbothane™ TPU, Isoplast® ETPU, Pellethane® TPU, Tecoflex™ TPU, Tecophilic™ TPU, Tecoplast™ TPU, Tecothane™ TPU (Lubrizol), Rilsan® HT, Arnitel® (DSM®), Solprene® (Dynasol®), Engage® (Dow Chemical®), Dryflex® and Mediprene® (ELASTO®), Kraton® (Kraton Polymers®), Pibiflex®, Forprene®, Sofprene®, Pebax®, and Laprene®. In other possible embodiments, degradable polymer composites may be mixed with other polymers such as rubbers, thermoplastics, or fillers to form composites and blends.

Examples of degradable polymers in accordance with the present disclosure also include aliphatic polyesters, poly(lactic acid) (PLA), poly(c-caprolactone), poly(glycolic acid) (PGA), poly(lactic-co-glycolic acid), poly(hydroxyl ester ether), poly(hydroxybutyrate), poly(anhydride), polycarbonate, poly(amino acid), poly(ethylene oxide), poly(phosphazene), polyether ester, polyester amide, polyamides that include any type of Nylon, which includes, but is not limited to, Nylon 6, Nylon 616, Nylon 6/12, etc., as well as the blends of different types of Nylons and the blends of Nylon with other polymers, sulfonated polyesters, poly(ethylene adipate), polyhydroxyalkanoate, poly(ethylene terephtalate), poly(butylene terephthalate), poly(trimethylene terephthalate), poly(ethylene naphthalate) and copolymers, blends, derivatives or combination of any of these degradable polymers. In one or more embodiments degradable polymer may also be manufactured to contain other additives that provide specific mechanical properties to the matrix polymer on the basis of the desired use. Additives dispersed throughout the polymer may modify mechanical properties such as the flexibility or stiffness of the matrix polymer. Polymer composite additives may include particulate or fiber additives such as glass fibers, carbon fibers, aramid fibers, metal fibers, ceramic fibers, and boron fibers.

In some embodiments, the macrostructure of the degradable polymer may affect the degradation times, such as the size and level of porosity content. Porosity of the matrix polymer, the continuous polymer phase of the degradable polymer, may control access of free water into the pores of the matrix polymer and affect the degradation rate. Modification of the matrix polymer porosity may also occur in degradable polymers having chemical crosslinkers that provide additional links between the chains of the matrix polymer and decrease the size of the observed pores. Additionally, degradation kinetics may be complicated by reverse condensation reactions such as intramolecular cyclization that can occur between amine and carboxylic end groups of a polyamide.

### EXAMPLES

In the following examples, degradable polymeric composites contacted with various aqueous catalyst solutions are assayed to determine degradation behavior. The examples are presented to illustrate the preparation and properties of degradable polymer composites and should not be construed to limit the scope of the disclosure, unless otherwise expressly indicated in the appended claims.

The degradable polyamide PA6 is a thermoplastic with extensive hydrogen-bonding between the amide bonds, which provides desirable mechanical properties and workability. PA6 composites are potentially degradable in aqueous fluids through amide bond hydrolysis. However, hydrolysis of PA6 and similar polyamides in water is slow, and degradation, as determined by loss of weight and mechanical strength, is within a reasonably short period of time requires temperatures above 110° C. Additionally, the degradation kinetics of the polyamide is complicated by competing reverse condensation reactions that occur under the same conditions as degradation.

Samples for the following experiments were prepared from a polyamide/carbon fiber composite (PA6-UCF, Cetex® TC910, a Nylon 6 carbon fiber unidirectional tape) commercially available from TenCate (Morgan Hill, Calif.). The tape is 0.16 mm thick and 166 mm in width with a density at 1.45 g/cm3, and the resin content is around 40% by weight.

To study the effects of polymer degrading catalysts on the degradation of the amide bonds in the polyamide composite, two Lewis acids were studied: ZnCl₂ (M(ZnCl₂)=136.32 g/mol) and AlCl₃ (M(AlCl₃)=133.34 g/mol). ZnCl₂ and AlCl₃ anhydride used in the following experiments were purchased from Sigma-Aldrich (St. Louis, Mo.).

The PA6-UCF tape was cut into pieces and molded into samples for tensile testing under ASTM D3039, compression testing under ASTM D3410, and dynamic mechanical analysis (DMA) samples with a hot press. When the temperature of the press reached 93° C., a pressure of 5 tons was applied to the mold. The temperature was allowed to rise to 249° C., at which point the pressure was released and the mold was cooled to room temperature. The surface of the samples can be sanded to give a smoother finish.

### Water Absorption of a Degradable Polymer

Samples of the PA6-UCF were subjected to isothermal water absorption experiments at 70° C. The mass and volume (width and thickness) dimensions of each original sample were measured using a Sartorius CPA 1245 analytical balance from Data Weighing Systems (Elk Grove, Ill.) and a Mitutoyo 500-170-20 caliper from Mitutoyo (Huntersville, N.C.). Next, samples were placed in glass vials containing 10 ml of deionized (DI) water. The samples in the sealed vials, with three to four samples in a vial, were placed in an oven at 38° C. and the mass of the wet samples were measured periodically until reaching a plateau where the samples were saturated with water. The same experiment was repeated at 98 and 150° C. (using a pressure vessel for 150° C. experiment). It takes about one hour for the pressure vessel to heat to and cool down from 150° C.

### Hydrolytic Degradation

In order to determine the rate of degradation, samples of PA6-UCF of varying sizes were submerged in water or aqueous solutions of polymer degrading catalysts at elevated temperatures. Prior to the study, the mass and volume dimensions of each original sample were measured. Next, control samples of the degradable polymers were placed into glass vials with approximately 10 ml of DI water. Samples were also assayed in aqueous solutions containing a Lewis acid polymer degrading catalyst. The concentration of the polymer degrading catalyst was maintained at a mole ratio of degradable bond (amide bonds in this case) to mole of polymer degrading catalyst, [RCONR′]:[M], of 3:1, or by varying percent by weight of solution (wt %) of catalyst in solution. The catalyst solution was prepared by slowly dissolving either ZnCl₂ or AlCl₃ in water at room temperature with constant stirring.

After submerging the sample in the selected aqueous fluid, samples were then placed in an oven at 98° C. for varying time intervals to determine the level of degradation. After the predetermined time intervals, samples were cooled to room temperature. The mass and volume dimensions at room temperature were re-measured for each wet sample immediately upon removal from water. The samples were then dried at room temperature under vacuum till the weight became constant, which was about a week for most samples. The mass and volume dimensions were again recorded for the dried samples. For the degradation experiments at temperatures higher than 100° C., the samples in un-sealed vials were placed inside a pressurized vessel, which was then sealed and placed in an oven for a selected time and temperature. The pressurized vessel took approximately an hour to equilibrate to testing temperature and then to cool to room temperature.

### End Group Analysis

The rate of hydrolysis of the PA6-UCF composites in water was tracked by titrating the generated carboxylic acid end groups. The dried polymer sample with known weight (around 0.3 g) was dissolved in 10.0 ml of benzyl alcohol after heating at 170° C. under N2 for 30 minutes. Around 8 drops of phenolphthalein indicator, 0.5% (w/v) in 50% (v/v) methanol, were added into the clear solution. The concentration of the acid end groups in each sample was titrated at 170° C. under N₂, using 0.0204 N KOH in methanol, and the end point was determined when the color of the solution turned to light pink. The blank titration was carried out using 10.0 ml of benzyl alcohol solvent only. The concentration of the end group (mol/g) was calculated using Eq. 1, where Vₚ is the volume (ml) of KOH solution for titrating the polymer, Vₐ is the volume (ml) of KOH solution for titrating the blank, and Wₚ is the mass of the polymer sample.

$$[ RCOOH ] = \frac{( {V}_{p} - {V}_{b} ) * {N}_{KOH}}{1000 * {W}_{p}} \qquad ( 1 )$$

### Attenuated Total Reflectance—Fourier Transform Inferred Spectroscopy (ATR-FTIR)

A Bruker VERTEX 70 spectrometer with an ATR unit was used to track the structure change of polymers before and after degradation. The ATR-FTIR allows for the infrared light to penetrate the sample surface at a consistently limited length (˜0.5 -2 μm). The solid sample was placed against the ZnSe crystal and each spectrum is an average of a total of 32 scans from 4000 to 600 cm⁻¹ with 4 cm⁻¹ resolution. The baseline of each spectrum was corrected. Differential Scanning calorimetry (DSC)

A TA Instruments Q200 DSC was used to measure the thermal properties, including temperature and enthalpy for both melting and crystallization, respectively, of the PA6-UCF samples before and after degradation. Approximately 10 mg of each polymer sample was sealed in an aluminum pan and loaded into the auto-sampler of the DSC. The samples were equilibrated at −50° C., ramped to 250° C. at 10° C./min, and then cooled back down to -50° C. at 10 ° C./min. Scans were repeated once to verify the degree of precision for the measurements. The specific enthalpy of melting was determined by integrating the peak of melting from the first scan. The percentage of crystallinity (X_{c}) was calculated according to Eq. 2 using the specific melting enthalpy of PA6 (ΔHₘ^{PA6,crystal}=230 J/g).

$${X}_{c} = \frac{Δ {H}_{m}^{PA 6}}{Δ {H}_{m}^{PA 6 , crystal}} \qquad ( 2 )$$

### Tensile and Compression Testing

A 5565 series Instron™ mechanical testing machine equipped with a 50 kN load cell was used to measure the tensile and compression strength of the samples. Samples were submerged in either DI water or an AlCl3 solution ([RCONR′]:[M]=3: I) at 70° C., 98° C., or 150° C. for varying amounts of time, with the mass recorded before and after exposure. After the specified exposure time, the samples were removed and tested in the Instron™ while still wet.

Tests were conducted inside an environmental chamber at room temperature, 70° C., 98° C., or 150° C., depending on the exposure conditions. Tensile tests were done at a rate of 5 mm/min, while compression tests were done at 1 mm/min. The tensile tests were stopped when the tensile load dropped to zero. The compression tests were stopped once the compression load showed a sudden drop of at least 40%. Two samples were tested at each condition.

### The Rate of Water Absorption

Determining the Fickian Diffusion coefficient allows us to quantify the water absorption and compare the kinetics of water absorption with that of hydrolysis. We used the 1D Fickian diffusion model, shown in Eq. 3, to derive the Diffusion coefficient (Dₓ) at each temperature. In Eq. 3, mₜ is the mass of the wet sample at time t, mᵢ is the mass of the original dry sample, and mₘₐₓ is mass of the wet sample at water saturation.

$$\frac{{m}_{t} - {m}_{i}}{{m}_{max} - {m}_{i}} = 1 - \frac{8}{{π}^{2}} {\sum }_{j = 0}^{∞} {( 2 j + 1 )}^{- 2} exp [ - \frac{{( 2 j + 1 )}^{2} {π}^{2} {D}_{x} t}{{a}^{2}} ] \qquad ( 3 )$$

Eq. 3 describes an infinite plate that has one-dimensional diffusion. Because the geometry of the experimental samples deviates from an infinite plate, an edge correction factor, shown in Eq. 4, is applied to provide a more accurate 1D diffusion coefficient (Dₓ) from the experimentally measured effective apparent diffusion coefficient (D_{eff}). An unconstrained optimization algorithm in MATLAB called “fminsearch” was used to derive the optimal 1D apparent diffusion coefficient D_{eff} from the experimental data collected at each temperature. Dividing D_{eff} by the square of the edge correction factor (f≈1.5 when a=3 mm, b=4.2 mm and c=22 mm from the measured sample dimensions) results in Dₓ of the polymer at the selected temperature as described by Eq. 4, where

$$f = 1 + 0.54 \frac{a}{b} + 0.54 \frac{a}{c} + \frac{{a}^{2}}{bc} .$$

Dₓ≅f⁻²D_{eff} (4)

### Determining Degradation by Weight Loss

Assuming the sample is spherical, the decrease of the sample volume due to loss of materials into the fluid should follow Eqs. 5 and 6, where M is the mass and r is radius of the sample.

$$\begin{matrix}M = ρ \frac{4}{3} π {r}^{3} & ( 5 ) \\ - \frac{dM}{dt} = - \frac{d ( \frac{4}{3} π r 3 ) ρ}{dt} = - \frac{4}{3} π ρ 3 r 2 \frac{dr}{dt} & ( 6 )\end{matrix}$$

Assuming dr/dt is constant, and r at time t is r²=cM^{2/3} , and c is a constant, Eqs. 7-9 show the derivation of the expression for mass at time t, where to is the time at maximum weight loss, M₀ is the original mass, and Mₜ is the mass at time t.

$$\begin{matrix}\frac{dM}{dt} = - {cM}_{t}^{2 / 3} & ( 7 ) \\ \int {M}_{t}^{- \frac{2}{3}} dM = \int - cdt & ( 8 ) \\ {M}_{t} = {( - ct + {M}_{0}^{1 / 3} )}^{3} & ( 9 )\end{matrix}$$

At t₀, Mₜ=M₀ when all of the original mass is lost, so M₀^{1/3}=ct₀ and Mₜ=C(t₀−t )³.

Thus, mass loss at time t is given by Eq. 10.

$$Δ M = {M}_{0} - {M}_{1} = {M}_{0} - {C ( {t}_{0} - t )}^{3} = {M}_{0} ( 1 - \frac{{C ( {t}_{0} - t )}^{3}}{{M}_{0}} ) = {M}_{0} ( 1 - \frac{{C ( {t}_{0} - t )}^{3}}{{Ct}_{0}} ) = {M}_{0} ( 1 + {( ( t - {t}_{0} ) / {t}_{0} )}^{3} ) \qquad ( 10 )$$

### Determining the Apparent Rate Constant of Hydrolysis

Chemical degradation for polyamide polymer PA6 is the result of hydrolysis of the amide bonds in the polymer chains to form a carboxylic acid and an amine end group. Water diffusion and hydrolysis occur predominately in the amorphous phase of the PA6, like other similar hydrolytic degradable semicrystalline polymers.

The reaction follows a pseudo first order reaction mechanism (Eqs 11-15) wherein the concentrations of water ([H₂O]) and the amide bonds [RCONR′] inside the sample are in excess to that of the acid end groups [RCOOH].

$$\begin{matrix}\frac{d [ RCOOH ]}{dt} = k [ {RCONR}^{′} ] [ {H}_{2} O ] [ RCOOH ] & ( 11 ) \\ \frac{d [ RCOOH ]}{dt} = {k}^{′} [ RCOOH ] & ( 12 ) \\ \frac{{[ RCOOH ]}_{t}}{{[ RCOOH ]}_{0}} = {e}^{kt} & ( 13 ) \\ Ln ( \frac{{[ RCOOH ]}_{t}}{{[ RCOOH ]}_{0}} ) = {k}^{′} t & ( 14 ) \\ {k}^{′} = k [ {RCONR}^{′} ] [ {H}_{2} O ] & ( 15 )\end{matrix}$$

Eqs. 11-15 imply the hydrolysis is catalyzed by acid inside the sample. Therefore, the slope of the plot of Ln([RCONH]ₜ/[RCONH]₀) as a function of time is the apparent rate constant k′ at the temperature. Mₙ is the number average molecular weight. The half-life of the reaction, t_{1/2}, can then be defined as the time when Mₙ decrease by 50%, such that t_{1/2}=Ln(2)/k′.

### Calculation of the Critical Dimension For Surface Erosion

Critical dimension L_{c} is defined as the critical thickness of the material within which the material completely degrades (hydrolysable bonds are reacted with water) and thus appears as bulk degradation. When the dimension of the material is thicker than L_{c}, the degradation of the material appears as surface erosion. We adapted the reported method of using the water diffusion coefficient Dₓ, the degradation rate constant k′ and the number average molecular weight Mₙ to estimate L_{c} via Eq. 16, where x is determined according to Eq. 17.

$$\begin{matrix}\frac{{L}_{c}^{2}}{Ln ( {L}_{c} ) - x} = \frac{4 {D}_{x}}{{k}^{′} π} & ( 16 ) \\ x = ln ( \sqrt[3]{\frac{{M}_{n}}{{N}_{A} ( N - 1 ) ρ}} ) & ( 17 )\end{matrix}$$

In Eq. 17, N_{A} is Avogadro's number (6.03×10²³), ρ is the density of the polymer (1.13 g/cm³ for PA6), and Mₙ of the PA6 is 17,900 g/mol measured by end group analysis. The molecular weight of the repeat unit of PA6 is 113.2 g/mol, the number of amide bonds per polymer chain, N, is 158, and xis calculated to be −16.7, which is in agreement with reported values.

### Diffusion Coefficient of Water Absorption

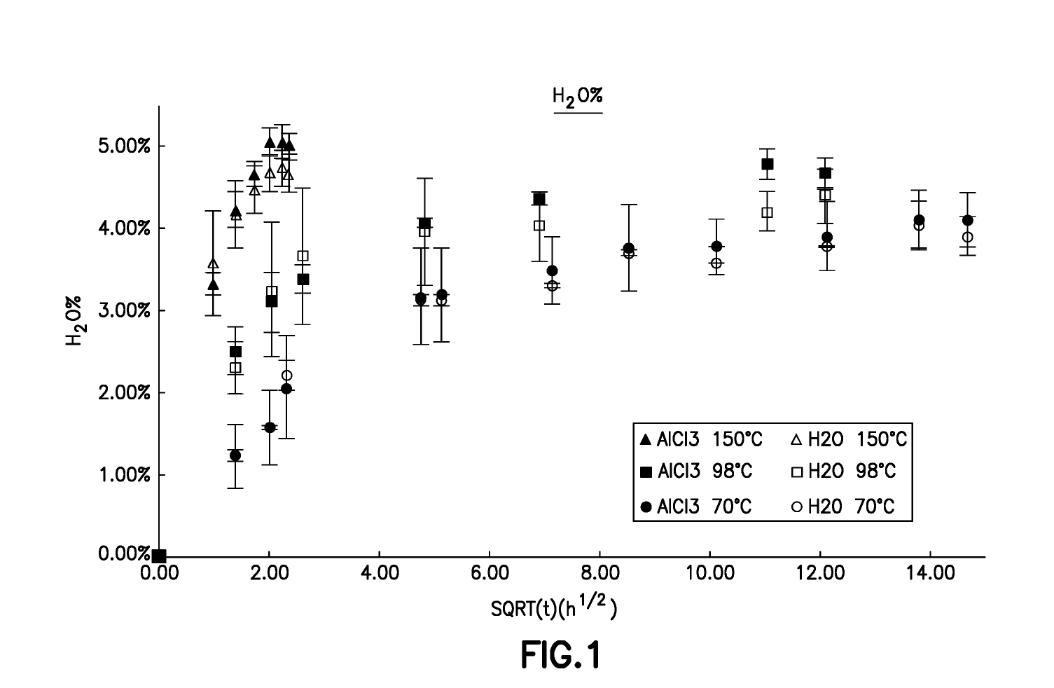

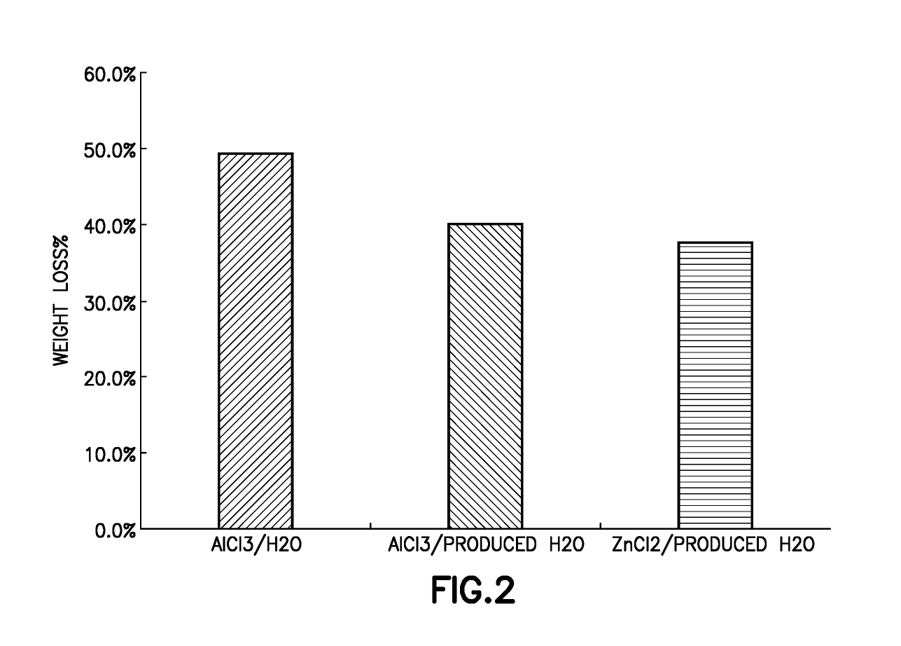

Prior to addition to the selected aqueous fluid, the surface of the PA6 was sanded. The mass and the volume of the samples increases as the samples absorb water or water in the treatment fluid containing 1 wt % AlCl₃. With respect to FIG. 1, the percent weight gain attributed to water absorption (H20%) as a function of the square root of time (SQRT(time)) for selected samples was recorded at 70° C., 98° C. and 150° C., where the studied temperatures are above the glass transition temperature, T_{g}, of the PA6 composite. The percent gain in volume (volume gain %) was also recorded for the same temperatures as shown in FIG. 2. The level of standard deviation between the samples was attributed to possible variation in porosity in the preparation of the polymer samples. Both volume and weight changes appeared to plateau around 4.5% after about 24 hours of water exposure at 70° C. and 98° C.

Applying an unconstrained optimization algorithm “fminsearch” in MATLAB to the ratios of the absorbed water at time t and at saturation, (mₜ-mᵢ)/(mₘₐₓ-mᵢ), optimal apparent diffusion coefficients 1D diffusion coefficient Dₓ were determined at each temperature as shown in Table 1 below.

TABLE 1
Coefficient of water diffusion Dₓ and degradation rate constant k′ at varying
temperatures

| | | | Predicted Dₓ | | | | |
|---|---|---|---|---|---|---|---|
| Temp. | Dₓ (m²/s) | Dₓ (m²/s) | (m²/s) | tₛ (days) | k′ (s⁻¹) | L_{c} (cm) | t_{1/2} (days) |
| (° C.) | H₂O | AlCl₃ | AlCl₃ | L = 2.5 cm | AlCl₃ | AlCl₃ | (L < L_{c}) |
| 70 | 7.12E−12 | 5.79E−12 | 5.95E−12 | 238.54 | — | — | — |
| 98 | 2.08E−11 | 1.63E−11 | 1.56E−11 | 91.16 | 2.25E−06 | 1.76 | 35.66 |
| 120 | N/A | N/A | 3.01E−11 | 47.13 | — | — | — |
| 150 | 7.96E−11 | 6.51E−11 | 6.63E−11 | 21.41 | 5.46E−05 | 0.7 | 1.47 |

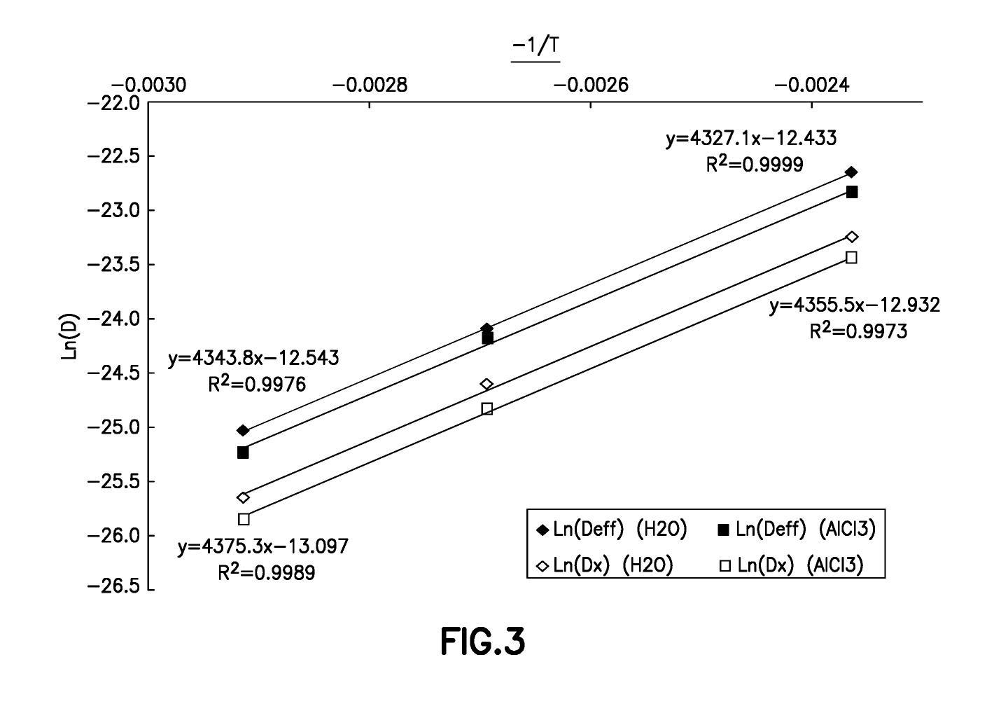

Table 1 shows Dₓ for the PA6-UCF. The Dₓ in water are slightly higher than those in 1% AlCl₃ solutions, similar to the observation of smaller Dₓ in saturated NaCl solution, but, as shown in FIG. 3, the activation energy of water diffusion, Eₐ, is around 36 kJ/mol for both solutions.

The results in Table 1 suggest that the underlying driving force for water penetration into PA6 composites is the same in water as in AlCl₃ polymer degrading catalyst solution. Using Eₐ, Dₓ may be derived for other temperatures above T_{g} (52° C.) and below the melting point (240° C.) of the PA6 composites, as demonstrated in Table 1 showing the calculated Dₓ in 1% AlCl₃ solution from 70° C. to 150° C. For temperatures below T_{g} of PA6, predictions may have larger errors because the degradable polymer has less free volume and chain mobility below their T_{g}. For example, the measured Dₓ of the same samples at 38° C. is 4.79E-13 m²/s, while the calculated Dₓ is 1.60E-12 m²/s—about three time larger than the measured D.

The most conservative estimation, using one-dimensional water diffusion with edge correction, of the time taken for a one inch (a=2.5 cm) thick sample to reach water saturation

$$( {t}_{s} = {( \frac{a}{4} )}^{2} \frac{π}{{D}_{i}} )$$

at 120° C. and 150° C. are 47 and 21 days, respectively. On the other hand, a thin sample (a=0.25 cm thick) takes about 11 and 5 hours to reach water saturation at 120 and 150° C., respectively.

### Degradation of Polymer Composites in Aqueous Fluids

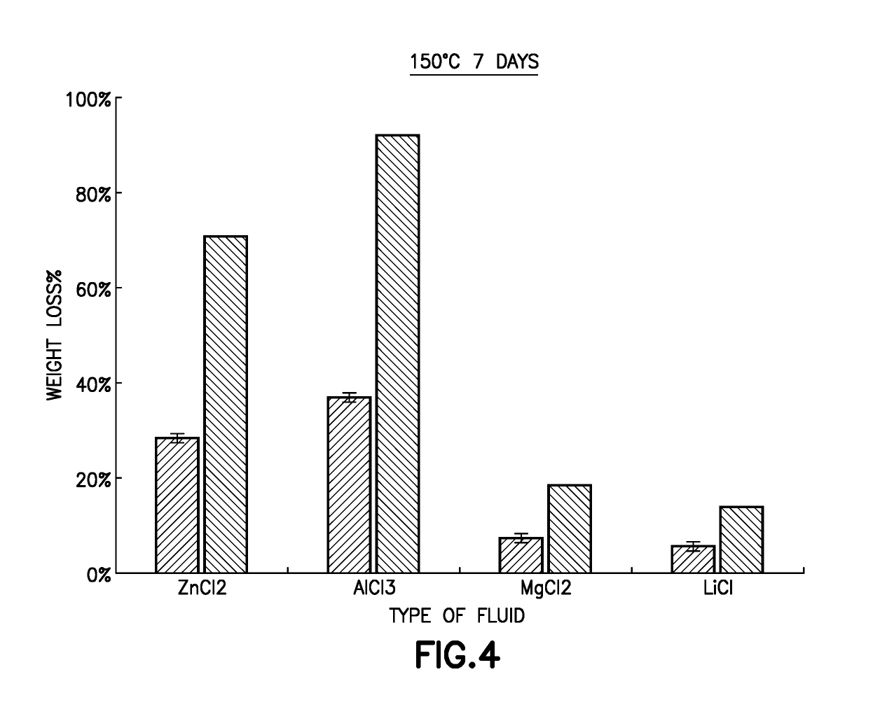

The degradation of PA6-UCF composite samples in aqueous solutions containing 1% by weigh (wt %) of ZnCl₂, AlCl₃, MgCl₂ or LiCl was studied by tracking the percent weight loss (wl %) of the PA6-UCF samples after seven days of degradation at 150° C. With particular respect to FIG. 4, the polymer degrading catalysts that have a higher Lewis acidity, AlCl₃ and ZnCl₂ in the group studied, appear to be more effective catalysts for the degradation of PA6 than MgCl₂ and LiCl, as indicated by much higher wl % at the same degradation conditions.

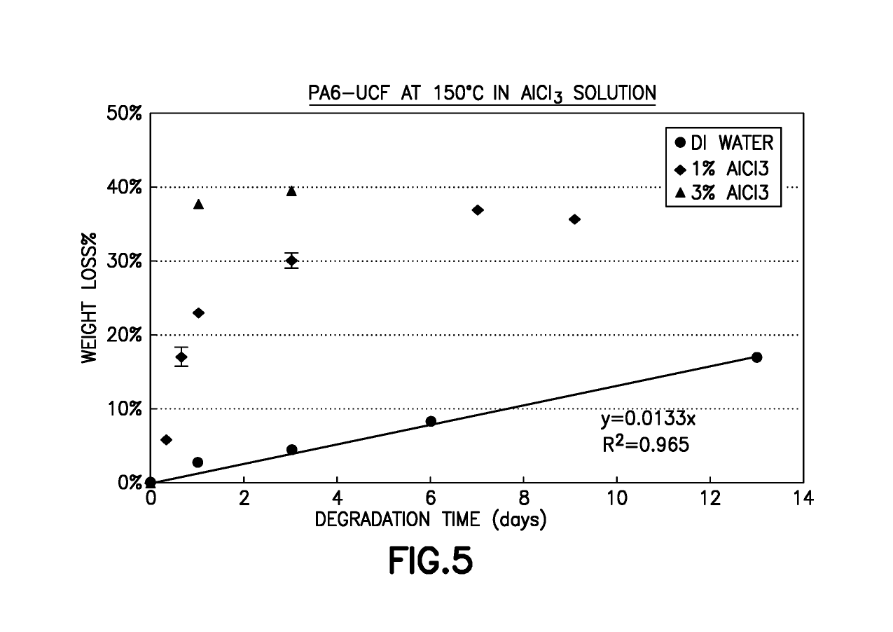

AlCl₃ appears to have somewhat higher efficacy than ZnCl₂ at the same concentration. The samples lost almost all of the polymers to leave only carbon fibers when degraded in 1% AlCl₃ solution while the same samples still maintain their shape with some polymer matrix left when degraded in 1% ZnCl₂ solution. With particular respect to FIG. 5, while increasing the concentration of AlCl₃ from 1% to 3% accelerates the degradation, weight loss at both concentrations occurs much more quickly than in DI water. Samples show substantial loss of polymer (weight loss%=39%) after one day at 150° C. in 3% AlCl₃ solution.

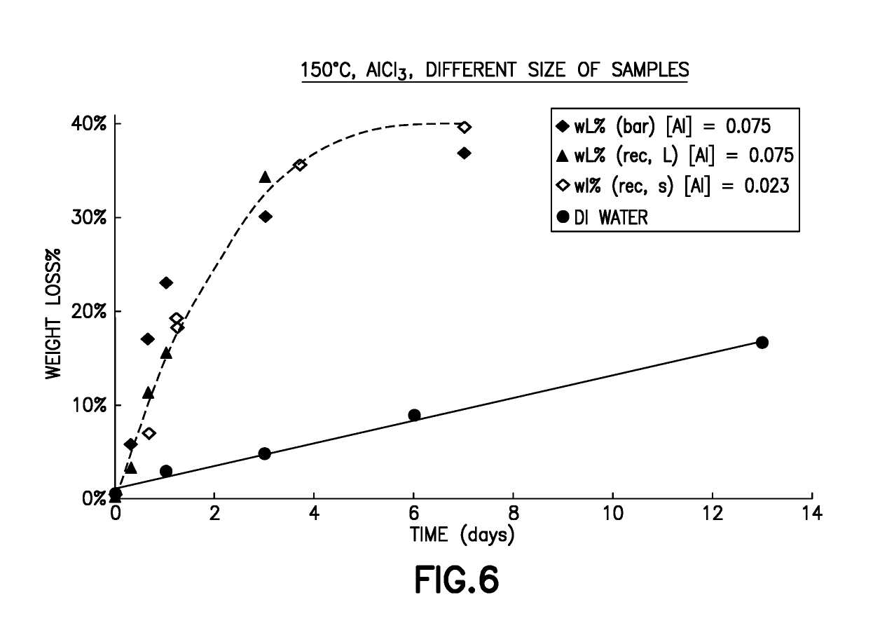

Several degradation experiments using different sizes of samples and in different concentrations of AlCl₃ solutions have demonstrated that the rate of degradation, as calculated by wl %, is proportional to the mole ratio of the total number of hydrolysable bonds in the polymer to the concentration of Al³⁺ ions in the solution. In the following experiments, the molar ratio of RCONR′:Al³⁺ is kept at 3. With particular respect to FIG. 6, the wl % of the prism bars (V=462 mm³ and 0.64 g), the large rectangle samples (rec L, 2937 mm³, 4.26g), and the small rectangle samples (rec s, 963 mm³, 1.37 g), all with the same thickness, over time at 150° C. in 1% (0.075 M) or 0.3% (0.023 M) AlCl₃ solution. Regardless of the variation of sample size or the weight and the concentrations of the AlCl₃ solution, the wl % follows the same trend and is much higher than the degradation in pure DI water at the same temperature. The dashed fit line for the weight loss% in AlCl₃ solution is derived from Eq. 10 using t₀ at 7 days.

### Degradation of Polymers in Produced Water

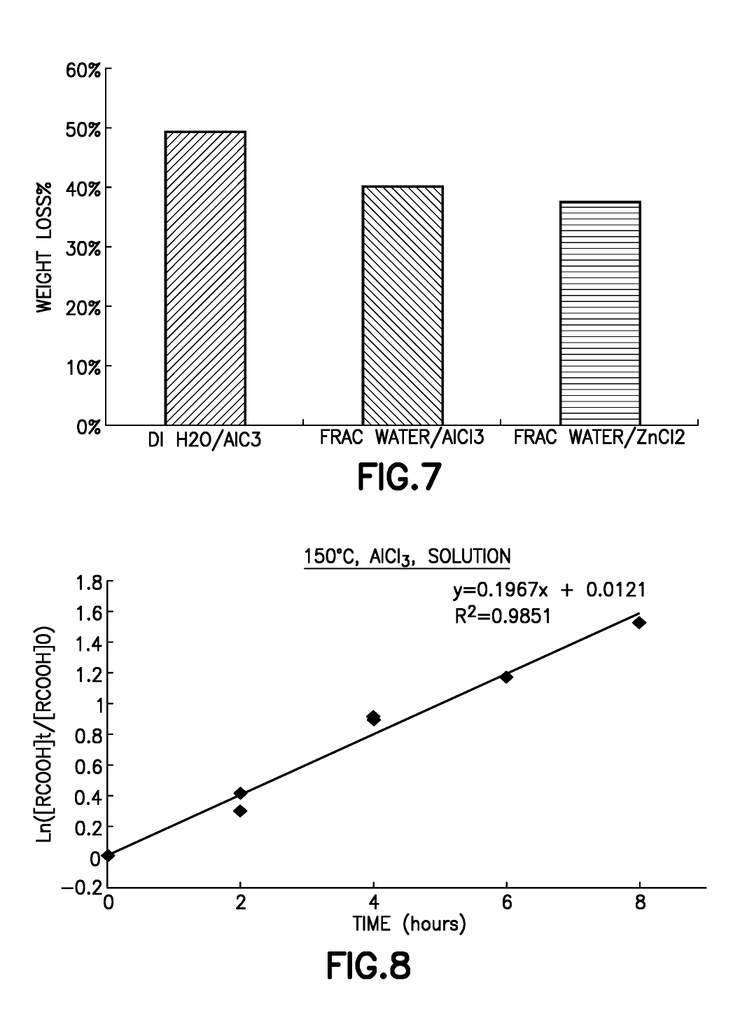

To demonstrate the compatibility of the polymer degrading catalysts with other chemicals that may be found during wellbore operating conditions, such as those present in produced water, degradation experiments were conducted on carbon fiber reinforced PA6 (PA6-CF) in ZnCl₂ and AlCl₃ solutions at a mole ratio of RCONR′:M=3 of DI water and of produced water, respectively. With particular respect to FIG. 7, the wl % of PA6-CF in produced water is only slightly lower than in DI water under the same loading of catalyst, and AlCl₃ is again more effective than ZnCl₂ after three days of degradation at 150° C. A qualitative analysis of the samples in AlCl₃ solution break down to powders after degradation.

### Determination of Hydrolysis Kinetics

Titration of the acid end groups of the dried PA6-UCF samples after degradation is a sensitive method to track the hydrolysis when there is no significant weight loss (early stage degradation). The PA6-UCF samples degraded at 98 and 150° C. within a relatively short time frame (no significant weight loss) were subjected to the end group analysis. The result supports the pseudo first order reaction kinetics (Eqs. 11-15) with a linear plot at each temperature studied. Particularly, the linear plot showing the natural log of the change in concentration of acid end groups at time t,

$$Ln ( \frac{{[ RCOOH ]}_{t}}{{[ RCOOH ]}_{0}} ) ,$$

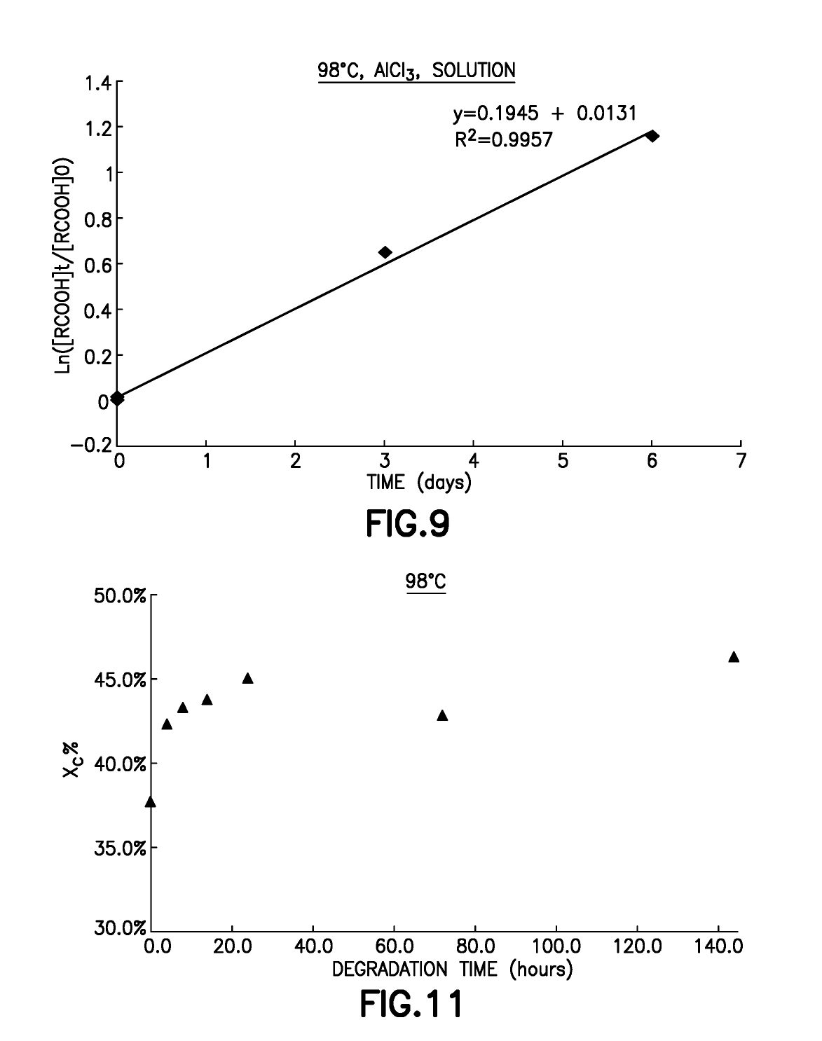

as a function of time is shown for 150° C. in FIG. 8 and at 98° C. in FIG. 9. The apparent rate constant, k′, at 98° C. was calculated as 2.25E-7 and 5.46E-6 s⁻¹ for 150° C. as shown in Table 1.

To illustrate the impact of temperature on the rate of material degradation, the time taken to degrade 50% of the amide bonds in the polyamide, t_{1/2}, is presented in Table 1. The results indicate that PA6-UCF should degrade reasonably fast for applications at temperatures above 120° C. in AlCl₃ solution when the degradable polymer thickness is less than the critical thickness L_{c}.

These results confirm that the rate of water diffusion is not the rate-limiting step and the produced acid groups catalyze the hydrolysis. Using Dₓ, k′, and Mₙ of the original sample (Mₙ=1/[RCOOH]₀=17,900 g/mol measured by end group analysis), we are able to estimate the critical thickness L_{c} using Eq. 16, assuming 1D water diffusion and bulk degradation is the predominant factor within L_{c}. Table 1 presents L_{c} corresponding to the rate constants and the diffusion coefficients at each temperature.

While not limited by any particular theory, it is believed that the sample will degrade layer by layer by surface erosion when sample thickness is greater than L_{c} (about 2 cm at 150° C. for the PA6 composite). L_{c} decreases as the temperature increases simply because Dₓ is less temperature dependent with smaller activation energy comparing to k′, and thus Dₓ/k′ decreases from 1.18E-4 to 1.65E-5 as the temperature increases from 98 to 150° C.

### Analysis by Attenuated Total Reflectance Fourier Transform Infrared Spectroscopy (ATR-FTIR)

Polyamide composites were also studied using ATR-FTIR to monitor the change in morphology of PA6 before and after degradation. PA6 is a semicrystalline polymer with α, β, and γ phases coexisting to maximize the number of H-bonding between NH and CO groups. Water often diffuses into the amorphous phase of the polymer and the corresponding hydrolysis of amide bonds in the amorphous phase can result in the change of certain characteristic peaks such as amide I (—C═O stretch), amide II (in plane N—H bend coupled with C—N stretch), and amide III (coupled N—H bend and C—N stretch as in amide II, but in an opposite phase).

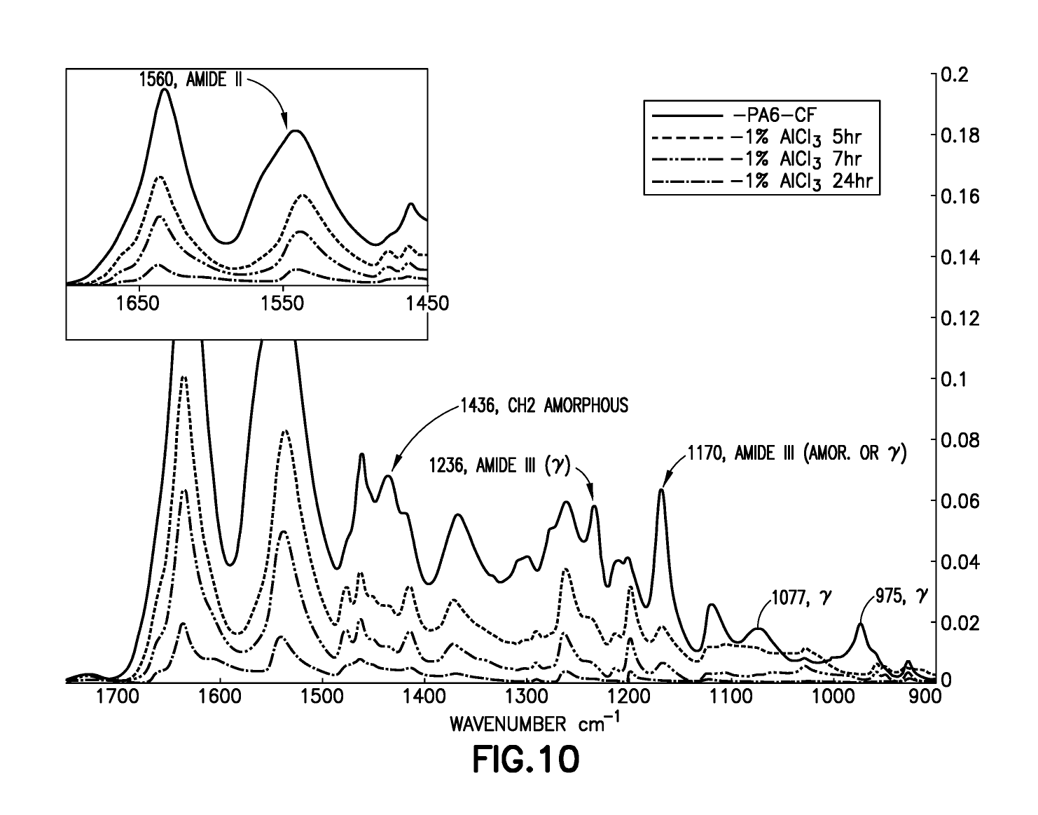

With particular respect to FIG. 10, the ATR-FTIR spectra of PA6-UCF before and after degradation at 150° C. in 1% AlCl₃ solution is shown. In the spectrum, in the non-degraded PA6-UCF, the peak at 1633 is the C═O stretch of amide I for crystalline phase, the peaks at 1560 cm⁻¹ and 1436 cm⁻¹ are from amide II, and the peak at 1170 are from amide III, which are all in the amorphous phase of the polymer. After degradation, the overall IR intensity of the peaks for the degraded samples decreases compared to that of the original sample for each of the studied times, which may be due to dissolution of PA6 on the surface of the samples after degradation. The relative intensity of the amide absorptions at 1560, 1436, and 1170 cm⁻¹ decreases after degradation, indicating hydrolysis of the amide bonds in the amorphous phase. Interestingly, the relative intensity of amide III at 1236, 1077 and 975 cm⁻¹ for γ phase also decreases after degradation, implying potential crystalline phase transformations at the degradation condition.

### Analysis Using Differential Scanning Calorimetry

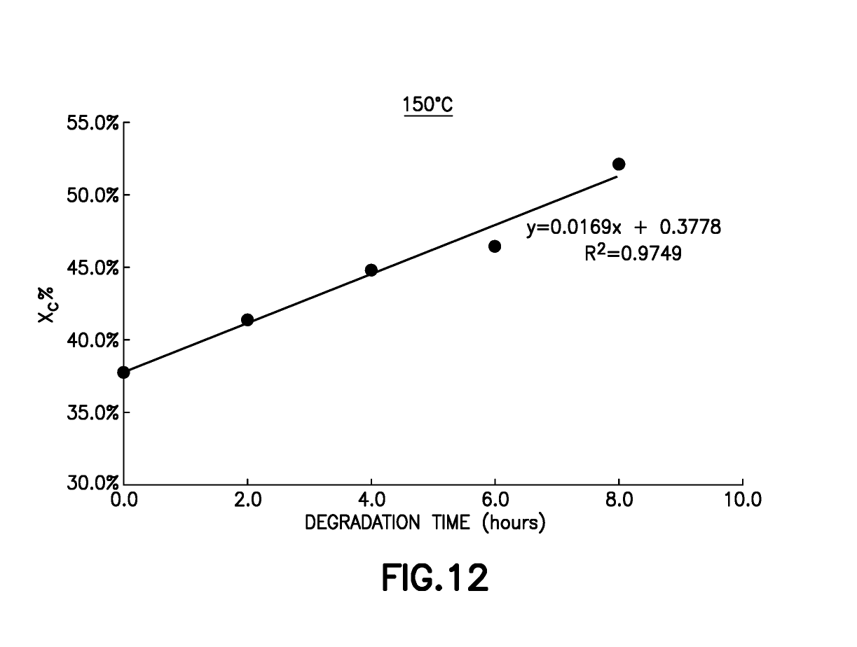

Using DSC, we are able to track the change of total crystallinity (as the percentage of crystallinity X_{c} %) following the progress of the degradation. With particular respect to FIG. 11, a plot of X_{c} % vs. degradation time is shown for PA6 composites before and after degradation at 98° C. At 98° C. and in 1% AlCl₃ % solution, X_{c} % increases rapidly within one day and plateaus at 45% for the six day study. With particular respect to FIG. 12, samples degraded at 150° C. exhibit a linear increase in X_{c} %, from about 37% to above 50%, after eight hours of degradation. The increase in crystallinity of the samples is believed to be due to the degradation processes that occur primarily in the amorphous phase that is vulnerable to water permeation. Alternatively, increasing X_{c} % could be attributed to the recrystallization of shorter polymer chains after degradation, or some combination of the two processes.

### Analysis of Mechanical Strength of PA6-UCF

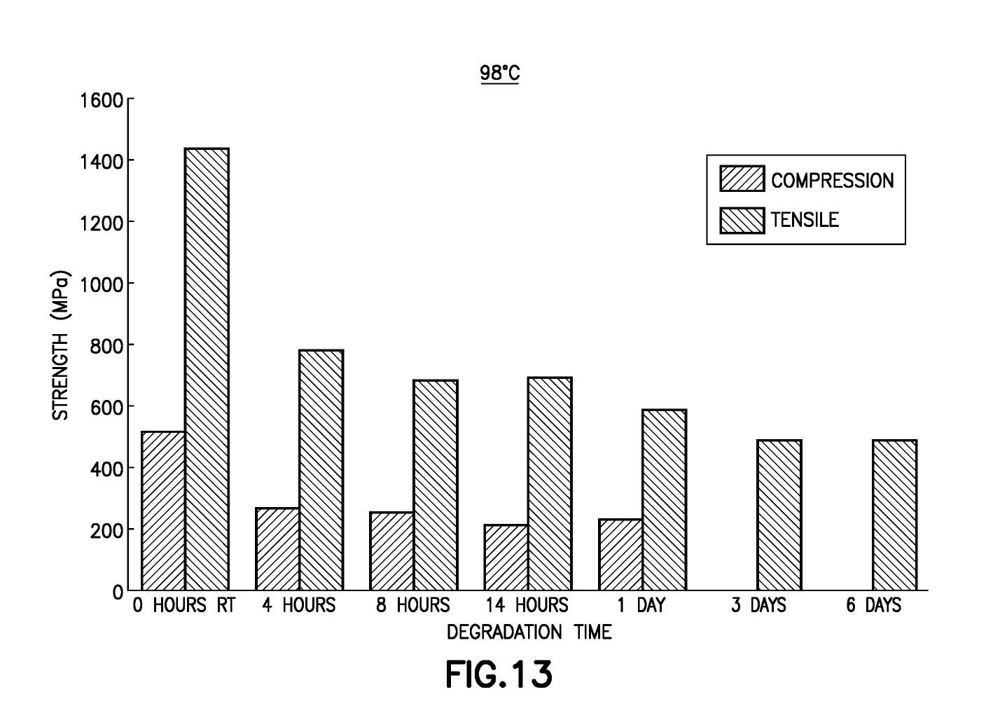

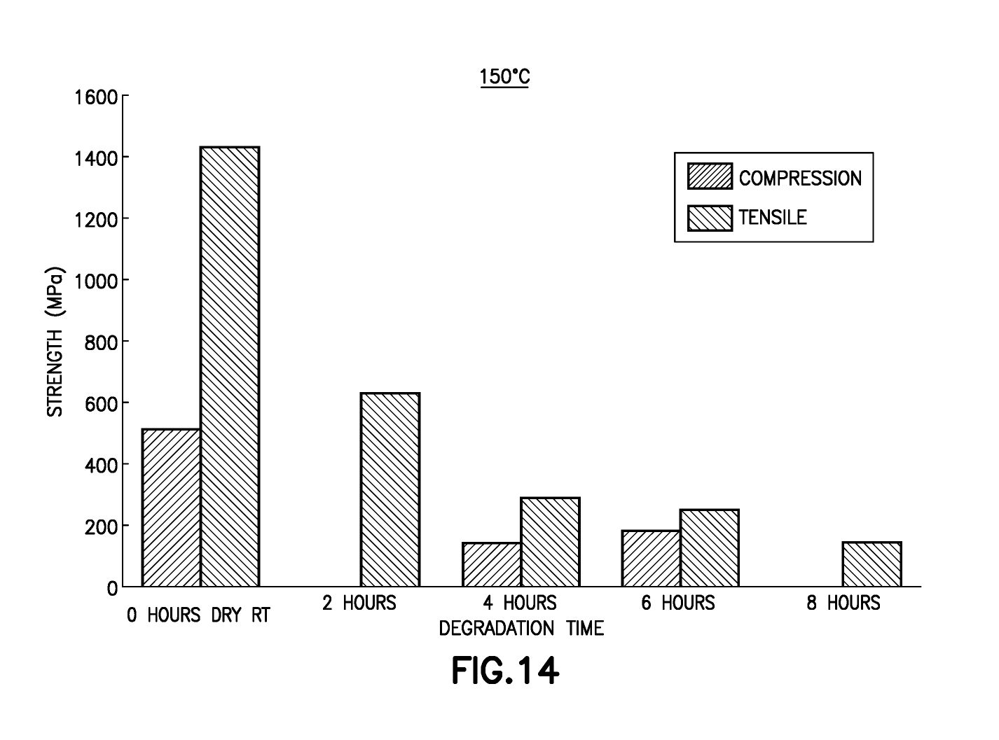

In the following example, the tensile and compression strength of wet PA6-UCF bars at 98° C. was measured before and after degradation in a 1% AlCl₃ solution at both 98° C. and 150° C. in order to study the changes in mechanical strength and crystallinity of the polyamide composites. As water diffuses into PA6-UCF, hydrolysis of amide bonds creates shorter polymer chains, which affects the mechanical properties of the bulk material. With particular respect to FIG. 13, there is a 50% reduction of the tensile and compression strength after one day of degradation at 98° C., and longer degradation times appear to result in slightly lower strength compared to the one-day samples. The amount of strength reduction in the degraded samples after one day in 1% AlCl₃ is similar to that of samples soaking in DI water after 2.5 hours at the same temperature, which suggests the initial drop of strength may be simply due to water penetration into the samples. The further drop of strength after 6 days of degradation could be the result of the reduction of polyamide molecular weight (Mₙ) from 17800 g/mol to 5600 g/mol. With particular respect to FIG. 14, the tensile strength decreases constantly following the progression of hydrolysis at 150° C. in a solution of 1% AlCl₃, and reaches 10% of the original value after eight hours of degradation. The Mₙ of PA also decreases from 17800 g/mol to 3900 g/mol for the samples degraded at 150° C.

The foregoing examples show that polymer degrading catalysts, such as ZnCl₂ and AlCl₃ dissolved in aqueous solutions, are effective catalysts to accelerate the degradation of PA6 composites, particularly at elevated temperatures. FTIR, DSC, Instron™ testing and end group analysis confirm that the degradation via hydrolysis takes place in the amorphous phase of PA6 and results in an increase of crystallinity, decrease of molecular weight and mechanical strength, and loss of materials. The determination of the number average molecular weight of PA, the coefficient of water diffusion, and the rate constant of hydrolysis of small coupon samples also allows the prediction of the degradation behavior of large, bulk materials in downhole conditions using a temperature-dependent model.

Although only a few examples have been described in detail above, those skilled in the art will readily appreciate that many modifications are possible in the examples without materially departing from this subject disclosure. Accordingly, all such modifications are intended to be included within the scope of this disclosure as defined in the following claims.

In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112(f) for any limitations of any of the claims herein, except for those in which the claim expressly uses the words ‘means for’ together with an associated function.

What is claimed:

1. A method comprising:
contacting a degradable polymer composite in a wellbore traversing a subterranean formation with a treatment fluid, wherein the treatment fluid is formulated with one or more polymer degrading catalysts; and
allowing the degradable polymer composite to at least partially degrade.

2. The method of claim 1, wherein the one or more polymer degrading catalysts are one or more selected from a group consisting of: TiCl₄, FeCl₃, ZnCl₂, ZrCl₂, AlCl₃, GaCl₃, BCl₃, ZnF₂, LiCl, MgCl₂, AlF₃, SnCl₄, SbCl₅, SbCl₃, HfCl₄, ReCl₅; ScCl₃, InCl₃, BiCl₃; NbCl₅, MoCl₃, MoCl₅, SnCl₂, TaCl₅, WCl₅, WCl₆, ReCl₃, TlCl₃; SiCl₄, FeCl₂, CoCl₂, CuCl, CuCl₂, GeCl₄, YCl₃, OsCl₃, PtCl₂, RuCl₃, VCl₃, CrCl₃, MnCl₂, NiCl₂, RhCl₃, PdCl₂, AgCl, CdCl₂, IrCl₃, AuCl, HgCl₂, HgCl, PbCl₂, sodium borate, sodium pentaborate, and sodium tetrab orate.

3. The method of claim 1, wherein the one or more polymer degrading catalysts are at least one of ZnCl₂ or AlCl₃.

4. The method of claim 1, wherein the one or more polymer degrading catalysts are selected from a group consisting of: Ca(OH)₂, Mg(OH)₂, CaCO₃, NaOH, KOH, MgO, CaO, ZnO and borate.

5. The method of claim 1, wherein the one or more polymer degrading catalysts are one or more polymeric solid acids.

6. The method of 1, wherein the concentration of the one or more polymer degrading catalysts is in the range of 0.1 wt % to 15 wt %.

7. The method of claim 1, wherein the degradable polymer composite contains one or more hydrolysable bonds selected from a group consisting of: amides, imides, anhydrides, carbamates, ureas, and esters.

8. The method of claim 1, wherein the one or more degradable polymers are one or more selected from a group consisting of: polyamide, polyamideimide, polyurethane, and polyester.

9. The method of claim 1, wherein the concentration of the polymer degrading catalyst is maintained at a mole ratio of degradable bonds to mole of polymer degrading catalyst is in the range of 10:1 to 1:1.

10. The method of claim 1, wherein the degradable polymer comprises all or a part of a downhole tool selected from a group consisting of: ball sealers, packers, straddle-packer assemblies, bridge plugs, frac plugs, darts, drop balls, seats, and loading tubes for perforating guns.

11. A method comprising:
determining at least one degradation characteristic for one or more degradable polymers;
formulating an aqueous treatment fluid based on the determined values, wherein the aqueous treatment fluid comprises one or more polymer degrading catalysts;
contacting the degradable polymer with an aqueous fluid; and
allowing the degradable polymer to at least partially degrade.

12. The method of claim 11, wherein the at least one degradation characteristic of the one or more degradable polymers is one or more selected from a group consisting of: the number average molecular weight of the degradable polymer, the coefficient of water diffusion for the degradable polymer, and the rate constant of hydrolysis for the degradable polymer.

13. The method of claim 11, wherein the one or more polymer degrading catalysts are one or more selected from a group consisting of: TiCl₄, FeCl₃, ZnCl₂, ZrCl₂, AlCl₃, GaCl₃, BCl₃, ZnF₂, LiCl, MgCl₂, AlF₃, SnCl₄, SbCl₅, SbCl₃, HfCl₄, ReCl₅; ScCl₃, InCl₃, BiCl₃; NbCl₅, MoCl₃, MoCl₅, SnCl₂, TaCl₅, WCl₅, WCl₆, ReCl₃, TlCl₃; SiCl₄, FeCl₂, CoCl₂, CuCl, CuCl₂, GeCl₄, YCl₃, OsCl₃, PtCl₂, RuCl₃, VCl₃, CrCl₃, MnCl₂, NiCl₂, RhCl₃, PdCl₂, AgCl, CdCl₂, IrCl₃, AuCl, HgCl₂, HgCl, PbCl₂, sodium borate, sodium pentaborate, and sodium tetraborate.

14. The method of claim 11, wherein the one or more polymer degrading catalysts are selected from a group consisting of: Ca(OH)₂, Mg(OH)₂, CaCO₃, NaOH, KOH, MgO, CaO, ZnO and borate.

15. The method of claim 11, wherein the polymer degrading catalysts are one or more polymeric solid acids.

16. The method of claim 11, wherein the one or more polymer degrading catalysts are ZnCl₂ or AlCl₃.

17. The method of claim 11, wherein the concentration of the one or more polymer degrading catalysts is in the range of 0.1 wt % to 15 wt %.

18. The method of claim 11, wherein the one or more degradable polymers are one or more selected from a group consisting of: polyamide, polyamideimide, polyurethane, and polyester.

19. The method of claim 11, wherein the concentration of the polymer degrading catalyst is maintained at a mole ratio of degradable bond to mole of polymer degrading catalyst is in the range of 10:1 to 1:1.

20. The method of claim 11, wherein the one or more degradable polymers comprises all or a part of a downhole tool selected from a group consisting of: ball sealers, packers, straddle-packer assemblies, bridge plugs, frac plugs, darts, drop balls, seats, and loading tubes for perforating guns.
